(19) United States
(12) Patent Application Publication
(10) Pub. No.: US 2015/0199927 A1
(43) Pub. Date: Jul. 16, 2015

(54) Full-Color Transparent Signage

(71) Applicant: Laurence Harrison, San Francisco, CA (US)

(72) Inventor: Laurence Harrison, San Francisco, CA (US)

(21) Appl. No.: 14/599,455

(22) Filed: Jan. 16, 2015

Related U.S. Application Data
(60) Provisional application No. 61/928,376, filed on Jan. 16, 2014.

(51) Int. Cl. G09F 13/18; G09F 13/00; F21K 99/00

(52) U.S. Cl. CPC G09F 13/18; F21K 9/30; G09F 13/005; G09F 2013/222

(57) ABSTRACT

An edge-lit sign includes several layers of transparent material. Each layer of the transparent material is etched to transmit light at the location of the etching. Each layer of material is lit by a different color. To display a multi-colored image in the edge-lit sign, the multi-colored image is associated with individual pixels. Each pixel is displayed by component colors in each layer of transparent material. At each layer of transparent material, a pixel is offset such that the etching for a pixel at each layer is not occluded by the etchings of another layer. In this way, when the layers are lit by lighting sources, the lighting for each layer may be viewed by a user to make a multi-colored image.

### BACKGROUND

In modern, lit signage there are effectively four major technologies: neon, printed signs with a backlight, LED-driven light sources, and edge-lit, etched material such as acrylic. Each of these technologies has advantages and disadvantages over the alternatives. For instance, printed signs are inexpensive, but are very common and fail to grab attention. LED-driven sources are either very expensive (for complete displays), or inexpensive but offer little customization. Likewise, neon is inexpensive for mass production but expensive for customization. Edge-lit acrylic, on the other hand, is inexpensive for customization, but lights the acrylic with a single color and cannot offer a full range of colors simultaneously.

### SUMMARY

This disclosure describes a solution for generating a full color gamut using layers of edge-lit transparent material, such as acrylic. Multiple pieces of etched transparent material are laid atop one another. Each layer of transparent material is etched with a design and can be separately edge-lit from a lighting source, such as an LED. The layer of transparent material transmits the light emitted from the lighting source throughout the layer of material, and the light is transmitted outward at the location of the etching. The etchings on each layer of transparent material are offset from one another, permitting light emitted from a lower layer to pass through the upper layers and be viewed simultaneously with the light from a higher layer. By combining layers of the transparent material, a viewer perceives the combination of colors emitted by each layer and permits the layered acrylic to show a wider array of colors beyond those colors used to light each layer. For example, in one embodiment, three layers of transparent material are used, edge-lit with red, green, and blue. By etching each layer to emit (or not emit) the component color in a specific area, offset to one another, a particular combination of these colors is shown to the viewer, causing the user to perceive additional colors, such as magenta, cyan, yellow, and white.

The amount of etching at a particular portion of a layer may also vary to also affect the amount of light emitted at that portion of the layer. For example, a wider or taller etch may also increase the amount of light emitted at a portion relative to a portion with a narrower or shorter etch. This also permits “mixing” of the emitted colors to create various shades of color. This enables a multi-colored image to be generated for display using edge-lighting of individual layers of the transparent material. In this way, inexpensive customization using the layered acrylic can be achieved for intensely attention-grabbing signage solutions. Various light sources for a particular layer may also be activated and deactivated to change the color display that layer. In another embodiment, an additional layer of acrylic can be activated and deactivated to create an animation. While typically described here with respect to an acrylic, any transparent material suitable for edge-lighting may be used.

### BRIEF DESCRIPTION OF THE DRAWINGS

FIG. 1A shows the frontal view, and FIG. 1B shows a cross-sectional view of an edge-lit etched material such as acrylic.

FIGS. 2A and 2B show multiple stacked acrylic layers in a similar structure to FIG. 1.

FIGS. 3A and 3B illustrate combining multiple edge-lighting colors to generate combined colors according to one embodiment.

FIG. 4 shows an example of creating a multi-colored graphic using multiple layers of acrylic.

FIG. 5 shows a device for lighting multiple layers of acrylic as a unit.

FIG. 6 shows an additional acrylic layer added to permit animation of the sign.

FIG. 7 shows keying the transparent material for the installation of the light sources in one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

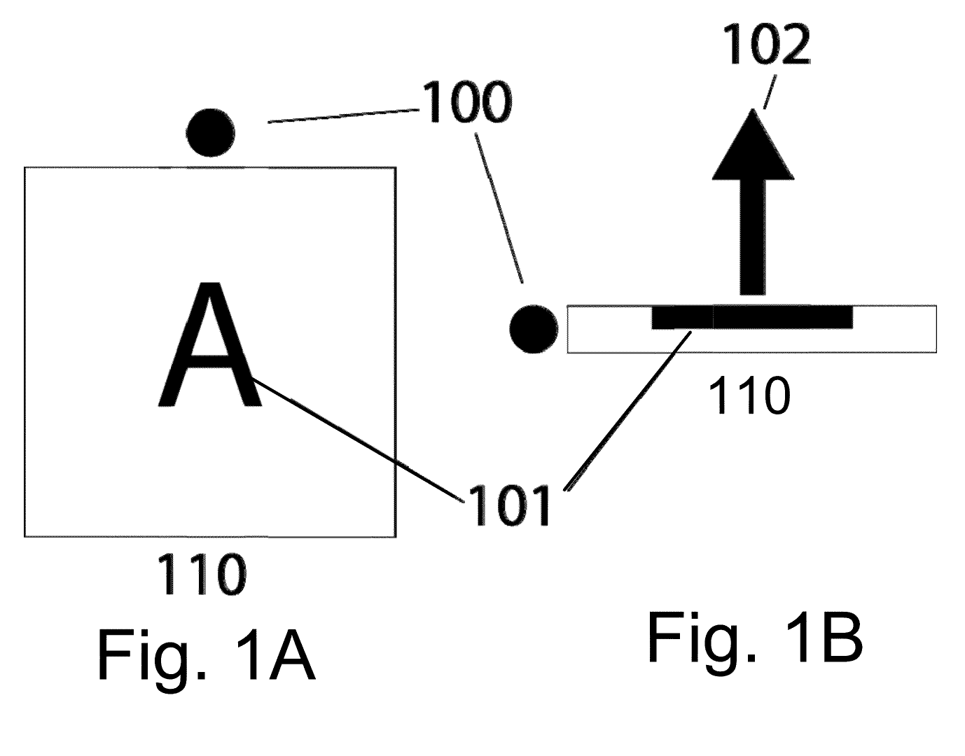

FIG. 1A shows the frontal view, and FIG. 1B shows a cross-sectional view of an edge-lit etched transparent material such as acrylic. For convenience throughout, the transparent material may also be referred to as acrylic, though other edge-lit transparent materials may also be used. A layer of transparent material 110 is lit by a lighting source 100 that transmits light through transparent material 110. The light emitted from a light source 100 travels through acrylic 110 and at the site of an etching 101, the light is redirected outwards and thus made visible by a user viewing the transparent material. The etching 101 is a depression on the layer of transparent material, typically formed by application of a laser or other cutting technique. The light source is typically an LED, though other methods may be used. Though FIG. 1A shows a single point light source, other configurations use a bar that extends at least partly around the edge of the transparent material 110, and may extend around the entire transparent material layer 110. FIG 1B shows the cross-sectional view of the transparent material 110 and shows transmitted light 102 when the light contacts the etching 101. Where the acrylic does not have an etching 101, light from light source 100 is not emitted.

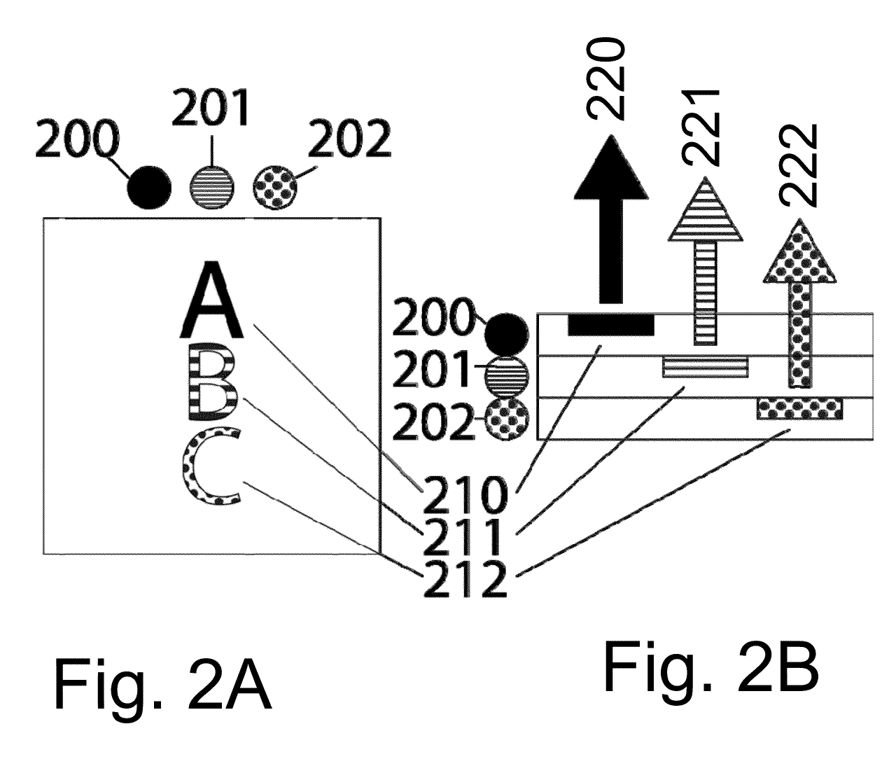

FIGS. 2A and 2B show multiple stacked acrylic layers in a similar structure to FIG. 1. In this example, multiple layers of acrylic are stacked upon one another. Here, separate light sources 200, 201 and 202 each light a different layer of acrylic. Each light source may be a different color, for example red, green and blue for light source 200, 201, and 202 respectively. Each acrylic layer receives its own etching 210, 211 and 212. In this example, each etching as shown by FIG. 2A is offset by one another and at least partially do not overlap. Since the acrylic is transparent, each etching is visible to the viewer at the front in its respective color as indicated by transmitted light 220, 221, and 222. That is, the etching 210 is on an acrylic layer corresponding to light source 200, and the etching of 210 redirects light passing through that etching outward to generate transmitted light 220. Likewise, etching 211 is located on an acrylic layer corresponding to light source 201 and transmits light 221. Thus, each layer of acrylic transmits light at the location of the etchings, and in the color of associated light source. Though the etching 212 in the letter “C” passes through two other layers to be visible to the user, the transparent acrylic permits the transmitted light 222 to pass through the other acrylic layers.

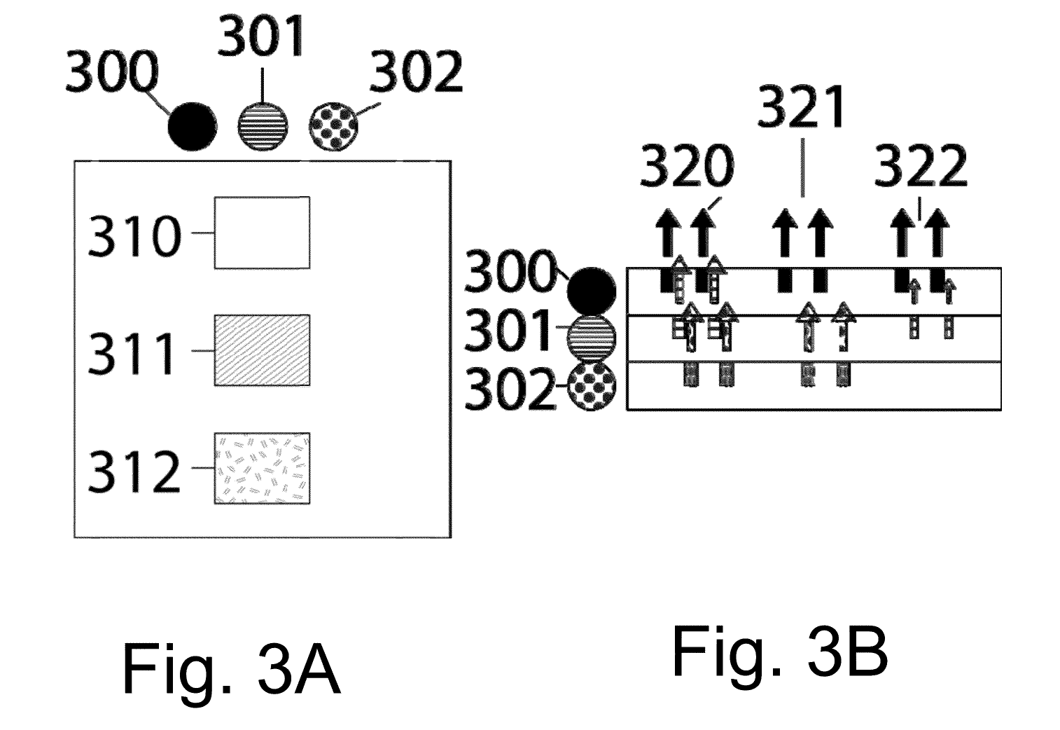

FIGS. 3A and 3B illustrate combining multiple edge-lighting colors to generate combined colors according to one embodiment. Here, light sources 300, 301 and 302 again light different layers of acrylic, for example in red, green and blue. However, the surface lighting on the acrylic have different colors based on etching at each layer of the acrylic. Surface lighting 310 represents a white square, surface lighting 311 represents a magenta square, and surface lighting 312 represents an orange square. In order to accomplish the presentation of these colors utilizing only red, green and blue light sources, the surface lighting areas are subpixeled by etching portions of each layer to emit the desired light sources from the layers beneath the surface lighting areas.

Emitted light 320 shows the etching at each layer for lighting the white surface lighting 310. White is represented by the combination of red, green and blue in full brightness. Small etchings of identical areas are made in each acrylic layer, close together but offset so as to allow the light beneath to flow through the transparent material. As the etchings themselves are not transparent, by offsetting the etching at each layer, the light emitted in each layer is transmitted through the transparent portions of other layers.

Emitted light 321 shows how this would be done for the magenta surface lighting 311. Similar to white, magenta is represented by the combination of red and blue in full brightness. Here, the same small etchings of identical areas are made, in the red and blue layers; the green layer at this portion is not etched and left transparent. However, the spacing for the etchings is maintained, thus providing a consistent brightness over the surface of the material.

The etching surface area is also used in embodiments to affect the brightness or strength of the light emitted by each layer. Emitted light 322 shows how this would be done for the orange surface lighting 312. Unlike the previous two examples, orange is represented by a combination of full brightness on red, but only half-brightness on the green. In order to alter the brightness for a given subpixel, the etching surface area itself is modified. Note the smaller outputs on the green layer here as consequence of the etching's reduced height. While shown in FIG. 3B as height, the surface area of the etching in the green layer may be reduced in any suitable dimension. The specific nature of the relationship between surface area and effective brightness is subject to different techniques, a few of which are discussed further below. By etching different layers offset from one another and etching them at different locations, many colors can be produced on the surface of the acrylic that differ from the colors of the light sources 300, 301, and 302. The various etching surface areas also permit increased or reduced amounts of light from each layer and associated light source.

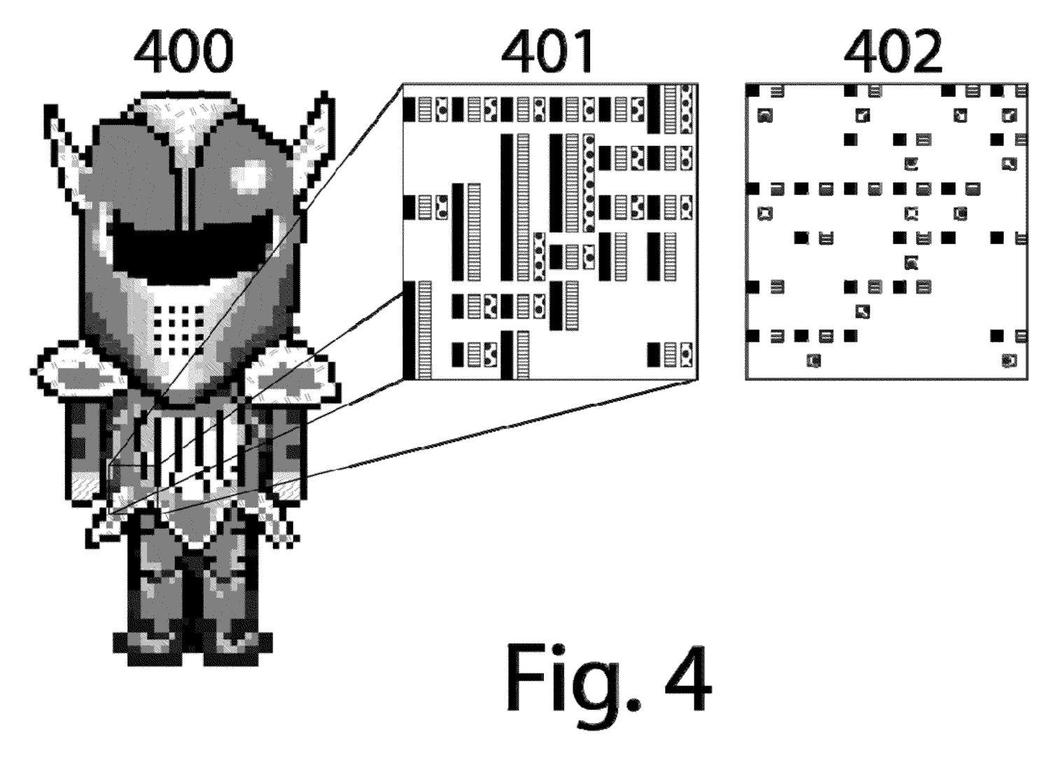

FIG. 4 shows an example of creating a multi-colored graphic using multiple layers of acrylic. Here, graphic 400 is converted for etching. The graphic 400 is converted into the component lighting colors (by subpixeling) of light sources 300, 301, and 302. These component colors are etched onto the associated acrylic layers. The etching for each layer thus may represent the amount of each component light associated with that layer. The etching at each layer may be offset to permit light from each layer to pass through the other layers for viewing. Close-up 401 is a converted image using one method of subpixeling with variable size etchings to achieve different brightness. Each pattern represents etchings on different layers, as shown in FIGS. 2 and 3. Close-up 402 shows the same area of the image converted instead using a constant-size subpixeling method and combined with a dithering technique, to achieve a full-color image without using variably-sized etchings of close-up 401.

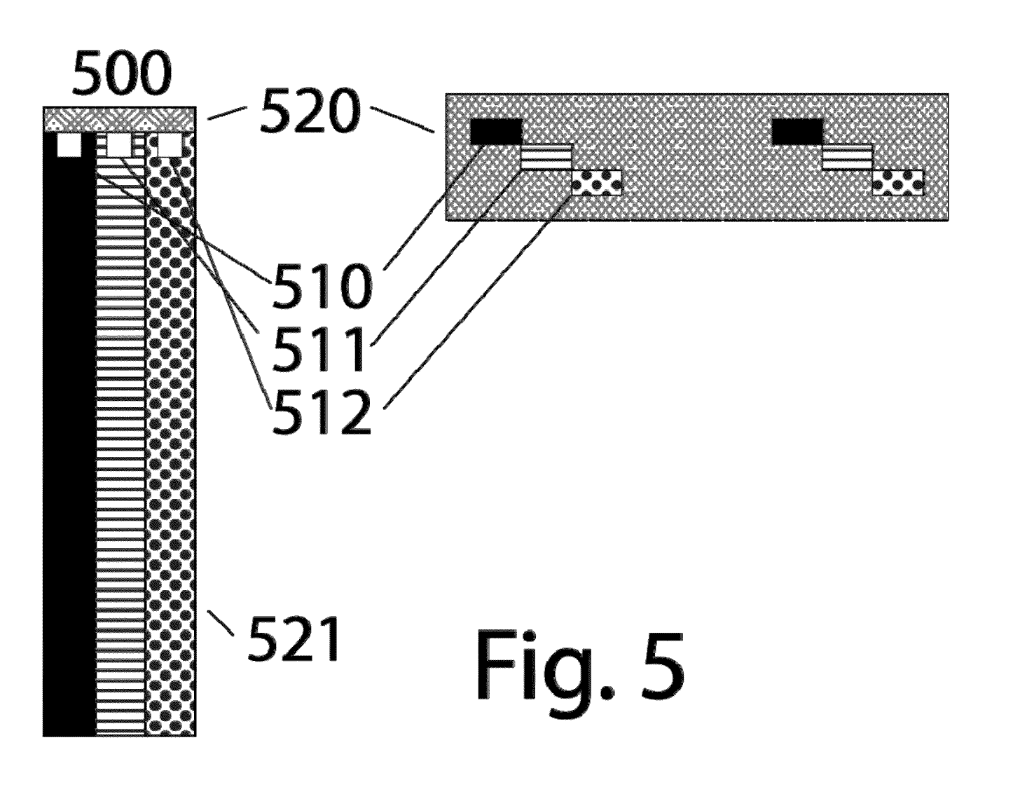

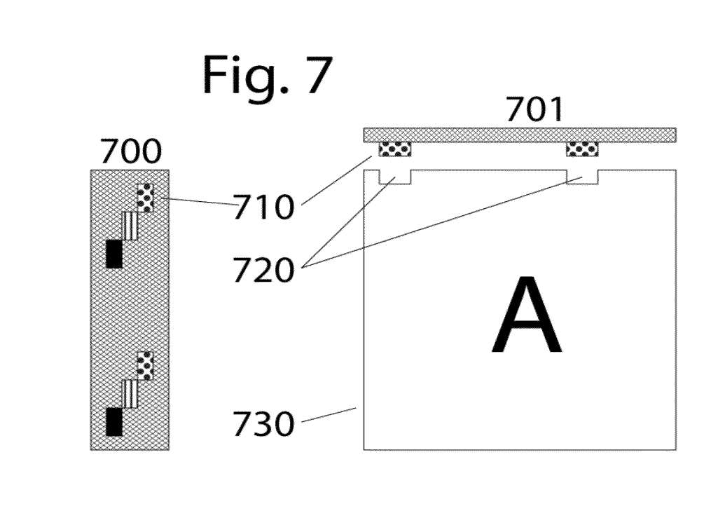

FIG. 5 shows a device for lighting multiple layers of acrylic as a unit. Here, a display 500 is shown in a side view with acrylic layers 521 as described above. The display also includes a circuitboard 520 installed at the top. Circuitboard 520 includes light sources 510, 511, and 512. For the purposes of demonstration, the light sources 510, 511 and 512 are red, green and blue light sources respectively in one embodiment, however in implementation these sources may be separated. In this case, light sources 510-512 are LEDs installed into the circuitboard used to edge-light the acrylic layers at several locations. A small area is cut away from the acrylic to insert the lighting sources in a portion of the edge of the transparent material, as further shown in FIG. 7.

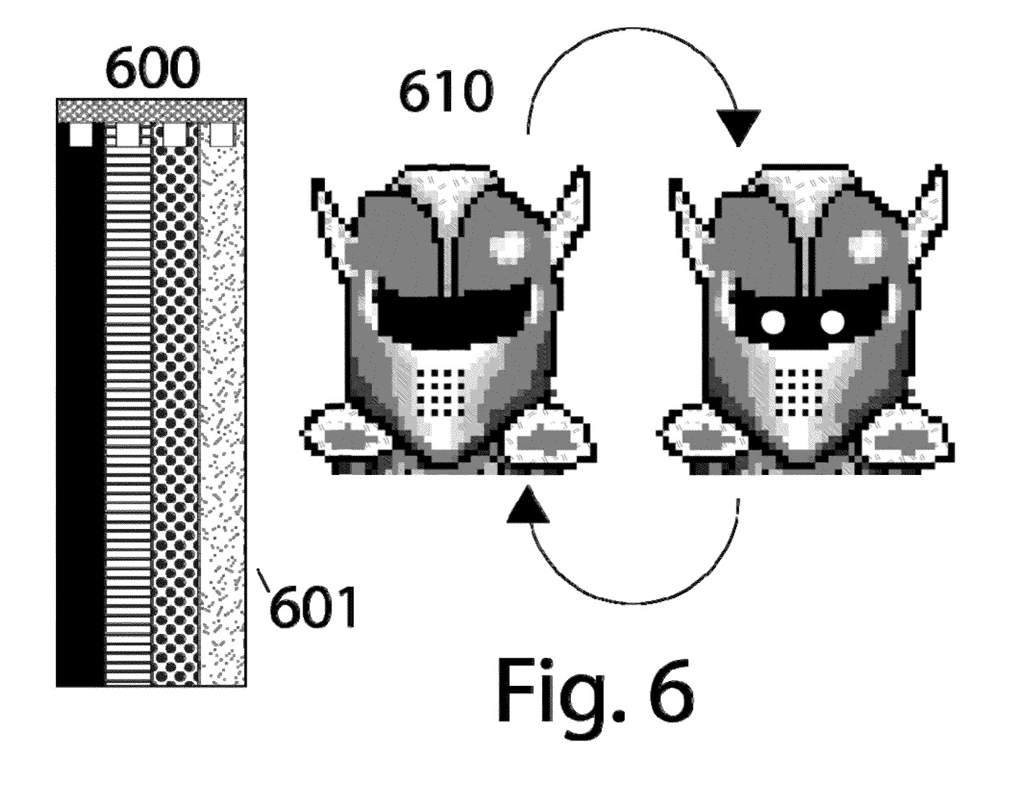

FIG. 6 shows an additional acrylic layer added to permit animation of the sign. Display 600 shows an extended circuitboard similar to FIG. 5 with an additional acrylic layer 601. The etching on layer 601 is used to provide an animation to the other layers. Animation 610 shows the effect of activating and deactivating the light source associated with the additional acrylic layer 601. In this example, additional acrylic layer 601 is etched in the shape of eyes on the helmet. When activated, the additional acrylic layer 601 provides an additional lighting element to the final displayed image. Additional layers can be incorporated for additional animation effects, and permit a user to combine additional colors of a light source using the additional acrylic layers.

FIG. 7 shows keying the transparent material for the installation of the light sources in one embodiment. In this example, the top portion of the transparent material is notched to permit the light source to be inserted into the layer of transparent material at an insert key. A circuitboard 700 in this example includes three light sources , each disposed at a different position along the length of the transparent material. A cutaway display 701 shows the same circuitboard from the side with only one row of lights 710 and one layer of material 730 for demonstration. Cutouts 720 (i.e., insert keys) are made to the single pane of material 730 so that the circuitboard 701 may sit flat atop the material 730. By using these cutouts 720, each lighting source may provide light to the associated layer. In addition, the cutouts may prevent each lighting source from providing light to adjacent layers.

Though each lighting source has been described as emitting an individual color, the lighting sources may be able to emit several different colors. The controller of the lighting sources may activate the lighting sources in various colors to create various effects through the etching. For example, the red-green-blue lighting sources described above may be cycled to display various colors by changing the red lighting source to green, the green to blue, and so forth.

As described herein, one may use the layered material to generated subpixeled images. That is, using one color per layer (e.g. one red, one green, one blue) and then stacking them to give the illusion of a full-color image.

As described herein, the use of three separate elements, each etched upon a separate layer (again, e.g. red, green, blue), separated and spaced so that through a transparent or translucent material they are all simultaneously visible permits a full-color image to be viewed.

To generate the full-color image, a source image is analyzed to determine colors associated with each pixel. Each color is associated with a specific layer of transparent material, and the quantity of each color associated with each color is associated with that layer of transparent material. The amount of etching for a given pixel is based on the quantity of color for that pixel and that layer of material. In particular, the physical area that is etched for that area is modified to dictate perceived brightness to a viewer. That is, the larger the etched surface area, the greater the effective brightness.

To determine the physical area from the quantity indicated by a pixel in the full-color image, the quantity of etching may be determined by a geometric area relationship, power area relationship, or logarithmic area relationship. In a geometric area relationship, for a given minimum brightness area A, each step up in brightness adds an additional A. Thus, the third step in brightness would have an area of 3*A, the fourth 4*A and so on. For a power area relationship, for a given minimum brightness area A, each step up in brightness follows the pattern (step #)2*A. Thus, the third step in brightness would have an area 3²*A=9*A, the fourth 4²*A=16*A and so on. For a logarithmic area relationship, for a given minimum brightness area A, each step up in brightness must be double (or triple, or quadruple, etc.) the previous level. Thus, the third step in brightness would be 2*(2*A)=2²*A=4*A, the fourth 2*(2*(2*A))=2³*A=8*A and so on.

The use of a single, constant area for each subpixel element but combined with alternative methods of image manipulation to generate a perceived full-color image, E.g. dithering.

These techniques can be used to light individual layers in any desired colors, though certain color combinations emitted by the light sources may not be capable of generating a full range of viewable colors.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention.

What is claimed is:

1. An edge-lit sign displaying a multi-colored image, comprising:
a plurality of layers of transparent material, each layer of transparent material etched at locations on the layer defining a set of pixels corresponding to the multi-colored image, wherein for each pixel, each layer of transparent material is etched at an offset relative to the etching for the other layers of transparent material; and
a plurality of light sources, each lighting source providing light for one of the plurality of layers of transparent material.

2. The edge-lit sign of claim 1, wherein the plurality of layers comprises three layers of transparent material and the plurality of light sources comprise red, green, and blue lights.

3. The edge-lit sign of claim 1, wherein each of the plurality of layers is etched at each pixel relative to an amount of light for that layer at that pixel.

4. The edge-lit sign of claim 1, wherein a controller is configured to control lighting the plurality of light sources.

5. The edge-lit sign of claim 4, wherein at least one of the plurality of layers is etched with a pattern associated with an animation of the multi-colored image and the controller is configured to control the plurality of light sources to display the animation.

6. The edge-lit sign of claim 1, wherein each light source is located at an insert key along the layer of transparent material.

7. The edge-lit sign of claim 6, wherein the insert key for each light source is located at a different offset along a length of the plurality of layers of transparent material.

8. A method for manufacturing an edge-lit sign comprising a plurality of etched layers of transparent material, comprising:
identifying a source image comprising a plurality of pixels;
identifying a set of colors associated with a plurality of layers of transparent material, each layer of transparent material associated with a color in the set of colors;
determining, for each pixel in the source image, an amount of each color of the set of colors matching the pixel;
associating each pixel with a location on each layer of transparent material, wherein the location for each layer is offset for each layer of transparent material; and
etching each layer of transparent material at the locations associated with an amount of color associated with the transparent material.

9. The method for manufacturing an edge-lit sign of claim 8, wherein the width and/or height of etching for each layer at a pixel is based on the amount of color associated with that layer at the pixel.
